(19) United States
(12) Patent Application Publication
(10) Pub. No.: US 2008/0223461 A1
(43) Pub. Date: Sep. 18, 2008

(54) One-Piece Self-Venting Drain Valve

(76) Inventors: Weston H. Gerwin, Perrysburg, OH (US); Michael S. Lynch, Fostoria, OH (US)

Correspondence Address: CANTOR COLBURN, LLP, 20 Church Street, 22nd Floor, Hartford, CT, 06103, US

(21) Appl. No.: 12/049,257

(22) Filed: Mar. 14, 2008

Related U.S. Application Data
(60) Provisional application No. 60/895,129, filed on Mar. 15, 2007.

(51) Int. Cl. F16K 24/00

(52) U.S. Cl. 137/588

(57) ABSTRACT

A self-venting drain valve for draining liquid from a vessel having an end opening through which liquid may drain and gas may simultaneously enter. The drain valve comprises a body portion and a stem portion. The body portion having a substantially tubular, internally threaded section and a vent permitting gas to enter. The stem portion has an externally threaded section and an aperture where liquid is permitted to drain from the vessel. The stem portion can be closed by engaging the externally threaded section with the internally threaded section, thereby preventing liquid and gas flow by sealing the vent and the aperture. The stem portion can be opened by disengaging the externally threaded section from the internally threaded section, thereby permitting liquid and gas flow simultaneously and separately by unsealing the aperture to permit liquid to drain from the vessel and unsealing the vent to permit gas to enter the vessel

### CROSS REFERENCE TO RELATED APPLICATION

This application claims the benefit of U.S. Patent Application Ser. No. 60/895,129, filed Mar. 15, 2007, the contents of which are incorporated herein by reference thereto.

### BACKGROUND

The present invention relates to self-venting valves, and, more particularly, to self-venting valves for draining water from fuel filter assemblies.

Various assemblies of self-venting liquid drain valves have been produced to provide for fluid drainage from a closed vessel. For example, in fuel/water separators used in internal combustion engines, water must be periodically drained using a valve assembly that is adapted to permit air to enter into a separator while the water is being drained. Some devices accomplish this by providing separate gas and liquid passages formed through portions of the valve assembly member. The separate passage for gas, such as air, is included in these devices to replace the liquid being drained

A problem that arises with fluid filter assemblies, particularly with those used for diesel and gasoline marine engines, is the removal of contaminants from the filter assembly. As fluid flows through a filter element, contaminants are separated therefrom and collect at the bottom of the vessel that is used to retain the filter element. These contaminants can include water and particulate matter suspended in the water, and must be periodically drained from the vessel. To remove these contaminants, drain valves are frequently positioned at the bottom of vessels. If a simple drain cock is utilized for the valve, the drainage may not be complete or may not occur at all because a partial vacuum is created in the filter housing upon the opening the valve assembly and initiation drainage. The partial vacuum prevents water from flowing through the open valve. Thus, rapid and complete draining can be effected only if ambient air is admitted into the vessel to break the vacuum therein.

To facilitate drainage by breaking the partial vacuum, many drain valves in fuel filters are self-venting, that is, they can allow ambient atmosphere to enter the filter when the valve is opened using vent holes. These vent holes, however, must be sealed when the valves are closed so that fluid within the fluid filter does not flow out through the vent holes.

Although current valve assemblies have been generally useful, they have had numerous disadvantages. Those which are self-venting have often been complex and made of multiple parts, making them expensive to manufacture and difficult to assemble. For example, some designs require one or more springs and/or a relatively complex arrangement of seals. Additionally, some drain assemblies have the disadvantage of allowing liquid drainage to leak through air vent passages. In fact, some valve assembly designs may initially draw drainage liquid into the vent passage during opening.

Accordingly, it is desirable to provide a self-venting drain valve for selectively permitting and preventing draining of contaminant liquid, such as water, from filter assembly housings and the like that is simple in construction, compact, inexpensive, reliable, and configured for ease of assembly and operation.

### SUMMARY OF THE INVENTION

Disclosed herein are exemplary embodiments of a self-venting drain valve for draining liquid from a vessel having an end opening through which liquid may drain and gas may simultaneously enter. The drain valve comprises a body portion and a substantially tubular stem portion. The body portion has an upper end, a lower end, and a substantially tubular, internally threaded section. The internally threaded section defines a body aperture opening at the upper end and extending therethrough to the lower end. The upper end is configured to be fixedly mounted on the vessel in coaxial alignment with the end opening. The body portion has a vent formed in the lower end. The stem portion has an exterior surface, an interior surface, an upper section, and an externally threaded lower section. The interior surface defines a stem aperture opening at the upper section and extending therethrough to the lower section. The stem portion has a groove formed in the lower section and opening radially through the exterior surface. The groove forms a first fluid passage through the stem aperture. The vent forms a second fluid passage through the body aperture between the internally threaded section of the body portion and the exterior surface of the stem portion. The stem portion is disposed and selectively positionable within the body aperture between a closed position and an open position. The stem portion can be positioned in the closed position by moving the stem portion upwardly through the body aperture into the vessel and threadably engaging the externally threaded lower section with the internally threaded section of the body portion. The stem portion thereby cooperates with the body portion when in the closed position to prevent liquid and gas flow through the fluid passages by sealing the vent and the groove. The stem portion can be positioned in the open position by threadably disengaging the externally threaded lower section from the internally threaded section of the body portion and moving the stem portion downwardly through the body aperture to engage the upper section with the body portion. The stem portion thereby cooperates with the body portion when in the open position to permit liquid and gas flow simultaneously and separately in the fluid passages by unsealing the groove to permit liquid to drain from the vessel through the first fluid passage and unsealing the vent to permit gas to enter the vessel through the second fluid passage.

### DESCRIPTION OF THE DRAWINGS

FIG. 1 is a cross-sectional view of an exemplary embodiment of a self-venting drain assembly in accordance with the present invention with the assembly in the closed position;

FIG. 2 is a cross-sectional view of the exemplary self-venting drain assembly of FIG. 1 with the assembly in the open position;

FIG. 3 is a perspective view of the exemplary valve element of the exemplary drain assembly of FIGS. 1 and 2; and

FIGS. 4 and 5 are bottom and top elevational views of the exemplary valve element of FIG. 3.

### DETAILED DESCRIPTION OF EXEMPLARY EMBODIMENTS

While the specification concludes with claims defining the features of the invention that are regarded as novel, it is believed that the invention will be better understood from a consideration of the description of exemplary embodiments in conjunction with the drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form.

Furthermore, the terms and phrases used herein are not intended to be limiting but rather to provide an understandable description of the invention. For instance, throughout the present specification, relative positional terms like ‘upper’, ‘lower’, ‘top’, ‘bottom’, ‘horizontal’, ‘vertical’, and the like are used to refer to the orientation of the exemplary embodiments shown in the drawings. These terms are used in an illustrative sense to describe the depicted exemplary embodiments and are not meant to be limiting. It will be understood that in particular applications, a valve assembly may be installed in an orientation different from that shown in the drawings (for example, inverted 180 degrees or transverse to that shown), and in such a case, the above-identified relative positional terms will no longer be accurate.

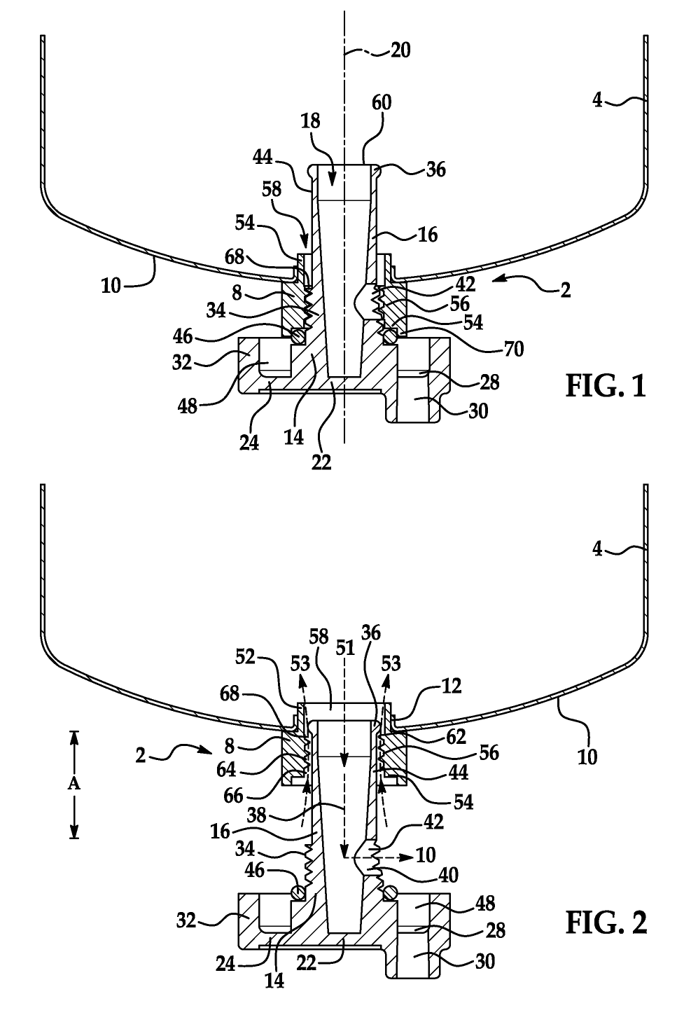

In accordance with the present invention, an exemplary embodiment of a self-venting drain valve assembly is illustrated in FIGS. 1 and 2. The valve assembly, indicated generally by 2, is illustrated in combination with a vessel 4 that may be a portion of the housing of a water/fuel separator. Such separators are frequently installed on the vacuum side of a fuel pump, which thereby subjects the interior of the housing to sub-atmospheric pressure. A compression spring (not shown) operates to properly position a filter (not shown) within the water/fuel separator. The structure of a conventional separator is well known and does not constitute any part of exemplary embodiments of a valve assembly in accordance with the present invention.

During operation of a water/fuel separator, water accumulates in the bottom portion of vessel 4. Solid particulate contaminants also tend to fall out of the fuel and water and accumulate in the space in the bottom of vessel 4. The accumulated water and contaminants are drained periodically to permit continued satisfactory operation of the separator. To perform this function, exemplary valve assembly 2 provides a drain path through which liquid collected in the base of vessel 4 may be drained out of the vessel while providing an independent passage for gas to enter vessel 4 simultaneously to break the vacuum within the vessel and facilitate drainage. As explained in greater detail below, valve assembly 2 provides a self-venting feature by a structure which is simple and inexpensive to manufacture.

Self-venting drain valve assembly 2 includes a substantially tubular collar or body portion 8, which is preferably of a one-piece construction, and a valve element 14, which is also preferably of a one-piece construction. Body portion 8 is disposed in an end opening 12 at the bottom surface 10 of vessel 4 that is coaxial with the vertical axis 20 of the vessel. As will be described below, valve element 14, which is selectively movable relative to body portion 8 between a fully closed position, depicted in FIG. 1, and a fully open position, depicted in FIG. 2, cooperates with body portion 8 to define flow paths for liquid and air.

Body portion 8, which may take the form of an annular weld nut in exemplary embodiments, is adapted to be fixedly mounted to the bottom of vessel 4. Body portion 8 includes a flanged upper end 52 and an opposing lower end 54. Upper end 52 projects substantially vertically through end opening 12 and into vessel 4, and lower end 54 is disposed outside the vessel. Body portion 8 has an annular internally threaded section 56 that defines a body aperture 58 in fluid communication with vessel 4. Body aperture 58 opens at upper end 52 in coaxial alignment with end opening 12 of vessel 4 and extends through body portion 8 to lower end 54.

Valve element 14 comprises a homogenously formed one-piece unitary valve body that, in exemplary embodiments, can be made of relatively lightweight and low-cost synthetic plastic materials that do not corrode when exposed to liquid flowing therethrough such as, for example, nylon 6/6 or glass filled nylon 6/6. In exemplary embodiments, valve element 14 is manufactured by injection molding. Alternatively, non-plastic corrosion-resistant materials, such as stainless steel or aluminum, may be used for manufacturing valve element 14. In alternative exemplary embodiments that permit the valve assembly to be used in marine applications, valve element 14 may be formed of die-cast zinc. Valve element 14 includes a stem portion 16 and a bottom portion 22 integrally juxtaposed to the lower end of the stem portion. Bottom portion 22 includes a radial flange 24 and a collector knob or operator 32 disposed around bottom portion 22 to facilitate manual rotation of valve element 14 and to assist in draining liquid, as discussed below.

Valve element 14 is rotatably and slidably received within body aperture 58 for reciprocating upward and downward movement within between a closed position, illustrated in FIG. 1, and an open position, illustrated in FIG. 2, with valve stem portion 16 extending through the body aperture 58 and bottom portion 22 being positioned outside vessel 4. When valve element 14 is in the open position, gas enters and liquid drains from vessel 4 along separate paths.

Stem portion 16 is generally cylindrical in shape and includes a substantially tubular wall section 44 defining an internal drain passage 18 through which liquid such as water collected in the bottom portion of vessel 4 may be drained out of the vessel. Drain passage 18 extends lengthwise through stem portion 16 between a radial cutout groove 42 and an upper drain port 60 at the top of the stem portion, as best illustrated in FIG. 2, and includes two segments, axial passage 38 and radial passage 40. Radial passage 40 and axial passage 38 are disposed at substantially 90° right angles to each other. Radial passage 40 opens at groove 42, through which liquid can drain out from vessel 4 and drain passage 18. A pair of opposing retaining nibs 36 project radially outward from a point adjacent to upper drain port 60 at the top of stem portion 16. Retaining nibs 36 are adapted to engage the top surface 62 of internally threaded section 56 of body portion 8 to retain valve element 14 within the body portion when valve assembly 2 is in the open position, as illustrated in FIG. 2. In exemplary valve assembly 2 of FIGS. 1 and 2, retaining nibs 36 are diametrically opposed at the top of stem portion 16.

An externally threaded section 34 is disposed between wall section 44 and bottom portion 22 on stem portion 16, in axial alignment with groove 42. Externally threaded section 34 is configured to be received within and threadably mate internally threaded section 56 of body portion 8. When valve assembly 2 is in the closed position, externally threaded section 34 engages internally threaded section 56, as shown in FIG. 1, to close off groove 42 and thereby seal radial passage 40 so that liquid in vessel 4 cannot drain from the water/fuel separator.

As described above, valve element 14 provides drain passage 18 through which liquid collected in the bottom portion of vessel 4 may be drained out from the vessel. Valve element 14 also cooperates with body portion 8 to provide an air passage 64 extending axially within body aperture 58 in the space defined between internally threaded section 56 of body portion 8 and the opposing wall section 44 of stem portion 16. When valve assembly 2 is disposed in the open position of FIG. 2, air passage 64 permits gas to enter vessel 4 and break the partial vacuum within the vessel, thereby facilitating the drainage of liquid through drain passage 18. As illustrated in FIG. 2, an annular air vent 66 axially formed through lower end 54 of body portion 8 provides an opening that communicates with ambient atmosphere to admit air into vessel 4 via passage 64. Air passage 64 thus extends independently of drain passage 18 within body portion 8 from air vent 66 to an annular upper air outlet port 68 axially formed in top surface 62 of internally threaded section 56 and in communication with the air passage.

As is illustrated in FIG. 2, when self-venting drain valve assembly 2 is in the open position, liquid flows in the path of arrow 51 through axial passage 38 of valve element 14 and drains out from radial passage 40 through groove 42, while gas follows the path of arrows 53 into vessel 4 to prevent a partial vacuum from occurring therein that would interfere with the flow of liquid out of the valve element. Stem portion 16 fits within body aperture 8 to isolate air passage 64 from drain passage 18 and thereby constrain liquid and air to flow along separate paths. Thus, valve assembly 2 provides a self-venting feature in a structure that is simple and inexpensive to manufacture. It preferable that the ratio of the area of outlet groove 42 to the area of inlet air vent 66 be between 10 and 20, and, more preferably, 15.

When exemplary valve assembly 2 is installed on a water/fuel separator, because water is heavier than fuel, water can accumulate in the bottom of vessel 4 while fuel remains above the top surface of the water. Valve element 14 is can thus be held in the FIG. 2 position by the person draining water from the water/fuel separator until only fuel drains therefrom.

The exemplary valve assembly that is illustrated in FIGS. 1 and 2, by providing an isolated air passage that axially extends in the space defined between internally threaded section 56 of body portion 8 and the opposing wall section 44 of stem portion 16, allows the length of the stem portion that is required for the valve assembly to be functional to be minimal. Thus, exemplary embodiments of a valve assembly in accordance with the present invention can be provided with a compact design that facilitates drainage of vessel 4 with minimal internal clearance requirements. When exemplary valve assembly 2 is in the open position, air outlet 68 and groove 42 are separated by a distance that is indicated by reference letter A in FIG. 2. In exemplary embodiments, distance A can be, for instance, one-half inch long.

In the present exemplary embodiment, during the opening of valve assembly 2, groove 42 opens slightly before air vent 66 opens to provide the proper flow sequencing. While air passage 64 remains sealed by externally threaded section 34 of stem portion 16 until valve element 14 is completely threadably disengaged from body portion 8, groove 42 becomes partially unsealed prior to valve element 14 being completely threadably disengaged from body portion 8. Additionally, wall section 44 of stem portion 16 is positioned between externally threaded section 34 and upper drain port 60 to allow liquid to flow into drain passage 18 at a point remote from gas flowing from air passage 64 through air vent 66 into vessel 4. Incoming gas, in the form of bubbles, is prevented from being pulled into the liquid drainage because wall section 44 cooperates with flanged upper end 52 of body portion 8 to force the air bubbles to rise upwardly away from the region of higher water velocity.

A gasket 46 is disposed circumferentially around the bottom of stem portion 16 just below externally threaded section 34. As shown in FIG. 1, when valve assembly 2 is disposed in the closed position, gasket 46 is trapped by a downwardly projecting annular protecting rib 70 at lower end 54 of body portion 8. The inner diameter of rib 70 is slightly larger than the outer diameter of gasket 46 to center the gasket on body portion 8 and prevent overtightening.

Gasket 46 thereby cooperates with lower end 54 and internally threaded section 56 of body portion 8 to effectively seal both air vent 66 and groove 42 to prevent gas and liquid flow to and from vessel 4 when valve assembly 2 is in the closed position. In exemplary embodiments, gasket 46 can be adhered to stem portion 16 or not bonded to any surface. In exemplary embodiments, gasket 46 can be in the form of a conventional O-ring made of any appropriate elastic material, such as rubber or nitrile.

Gasket 46 is the only gasket required. Thus, exemplary valve assembly 2 can be provided using only a single sealing surface. Additional radial seals or gaskets are unnecessary, thereby greatly simplifying the assembly and production processes and simplifying the configuration of the valve assembly.

When valve assembly 2 is disposed in the closed position shown in FIG. 1, valve element 14 is threadably engaged with body portion 8 in its upper-most position, with externally threaded section sealing off air passage 64 to close off communication between air vent 66 and vessel 4. Further, internally threaded section 56 of body portion 8 seals against groove 42 such that communication between drain passage 18 and vessel 4 is also closed. Also, gasket 46 is positioned to prevent leakage around that interface. Thus, both drain passage 18 and air passage 64 are sealed against communication with vessel 4.

To open valve assembly 2 when valve element 14 is threadably engaged with body portion 8 in the closed position, the valve element can be rotated and unscrewed to threadably disengage externally threaded section 34 of stem portion 16 from internally threaded section 56 of base portion 8. Wall section 44 of stem portion 16 can then be moved downwardly through body aperture 58 and bottom surface 10 of vessel 4 until retaining nibs 36 engage top surface 62 of internally threaded section 56 to retain valve assembly 2 in the open position and prevent stem portion 16 from falling out of the vessel. At this point, liquid in vessel 4 will siphon out of the vessel from upper drain port 60 through drain passage 18.

During the process of opening of valve assembly 2, the partial unscrewing of the engagement between the threaded sections results in a lower portion of groove 42 becoming unsealed below lower end of body portion 54 such that drain passage 18 becomes free to communicate with vessel 4. That is, contaminant liquid may then proceed at least partially down drain passage 18. At this stage, the isolation in air passage 64 between air vent 66 and air outlet port 60 is maintained by externally threaded surface 34 of stem portion 16 until externally threaded section 34 is completely disengaged from internally threaded section 56 of base portion 8. Thus, depending upon the type of liquid being drained, as well as other factors, the liquid drainage may be halted by a partial vacuum formed by the partial exiting of some liquid, or, alternately, may flow out in irregular fashion caused by the partial vacuum.

Upon moving valve element 14 further downward to the open position of FIG. 2, both groove 42 and externally threaded section 34 will have become entirely clear of both internally threaded section 56 and air vent 66. With valve assembly 2 then fully open, liquid drainage from vessel 4 can proceed rapidly through drain passage 18 and out of groove 42. Venting gas can freely proceed through air passage 64 to replace the drained liquid in vessel 4, thereby avoiding any partial vacuum which might otherwise form. By virtue of the timed opening in which groove 42 communicates with upper drain port 60 and vessel 4 before air vent 66 communicates with upper air outlet 68 and the vessel, virtually no liquid drainage will occur through air passage 64. Thus, in this arrangement, threaded sections 34 and 56 are quite removed from the drainage liquid.

When valve assembly 2 is in the open position, liquid will be siphoned through drain passage 18 because the lower portion of the drain passage (that is, radial passage 40 and groove 42) is lower than the point of entry of air into vessel 4 as allowed by air outlet port 68. As discussed above, this distance, indicated by reference letter A in FIG. 2, should be at least approximately one-half inch to provide the proper siphoning of liquid from the vessel under vacuum conditions. After liquid exits drain passage 18 through radial passage 40 and groove 42, it is caught by valve operator 32.

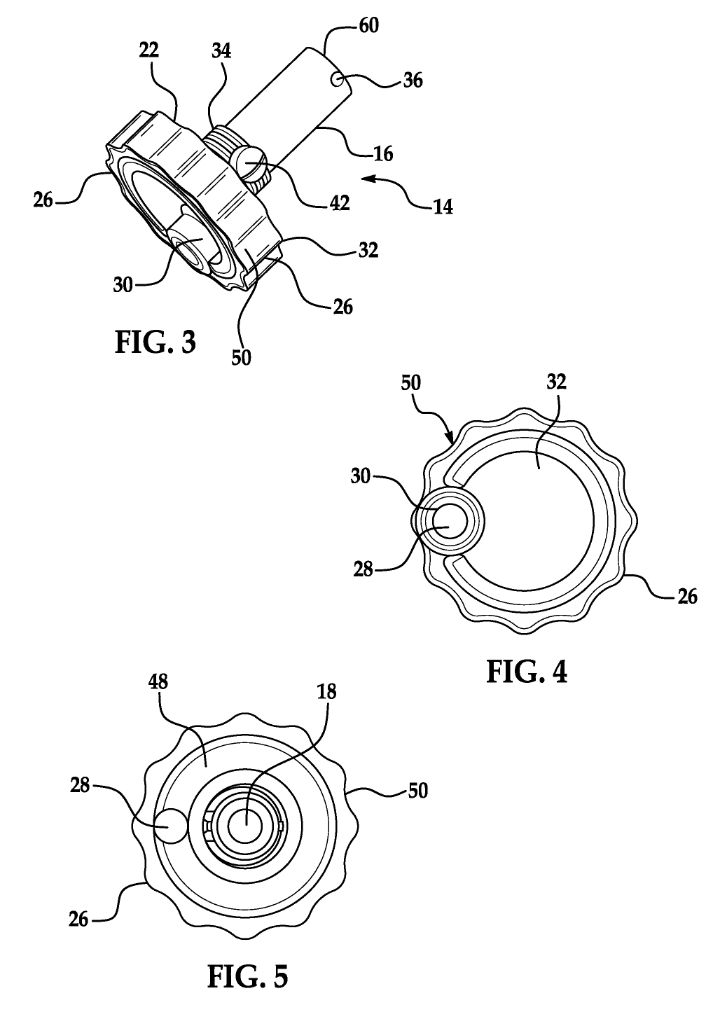

Reference is now specifically made to FIGS. 3-5, which illustrate more completely the features of exemplary valve element 14. Valve operator 32 includes a substantially annular groove 48 facing stem portion 16 and defining a drain reservoir, and a drain spout 30 forming an axial cutout passage 28 through which the water drains. Cutout passage 28 is open to the drain reservoir at an upper end thereof, and to the ambient atmosphere at a lower end thereof. Drain spout 30 allows connection of a hose to drain fluid into a container without spillage. Additionally, valve operator 32 is cup-shaped to accumulate liquid being drained and also collects any liquid which may leak through the space between externally threaded portion 34 of stem portion 16 and internally threaded section 56 of body portion 8 when valve assembly 2 is in the closed position. A generally cylindrical outer peripheral surface 50 of valve operator 32 can be provided with axially oriented ribs 26 to facilitate manual gripping of the valve operator.

In an alternative exemplary embodiment, bottom portion 22 of valve element 14 can include a cutout to facilitate rotation of the valve element 14 between the closed position and the open position using a metric wrench. The wrench socket may be of any appropriate shape, such as hexagonal or square.

The exemplary embodiments of a valve assembly described herein can provide a simple self-venting liquid valve using only one gasket seal to achieve the two isolated liquid and gas flow passages. Liquid such as water is permitted to drain while gas such as air can enter the vessel to replace the liquid being drained, thereby facilitating drainage even when the vessel is subjected to a vacuum. The gas does not mix with the draining liquid in the valve assembly and does not interfere with the draining of liquid from the vessel. The exemplary embodiments described herein can be is relatively simple and inexpensive to manufacture because of the simplicity of design.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A self-venting drain valve for draining liquid from a vessel having an end opening through which liquid may drain and gas may simultaneously enter, the drain valve comprising:
a body portion having an upper end, a lower end, and a substantially tubular, internally threaded section, the internally threaded section defining a body aperture opening at the upper end and extending therethrough to the lower end, the upper end being configured to be fixedly mounted on the vessel in coaxial alignment with the end opening, the body portion having a vent formed in the lower end; and
a substantially tubular stem portion having an exterior surface, an interior surface, an upper section, and an externally threaded lower section, the interior surface defining a stem aperture opening at the upper section and extending therethrough to the lower section, the stem portion having a groove formed in the lower section and opening radially through the exterior surface, the groove forming a first fluid passage through the stem aperture, the vent forming a second fluid passage through the body aperture between the internally threaded section of the body portion and the exterior surface of the stem portion, the stem portion being disposed and selectively positionable within the body aperture between a closed position and an open position,
wherein the stem portion can be positioned in the closed position by moving the stem portion upwardly through the body aperture into the vessel and threadably engaging the externally threaded lower section with the internally threaded section of the body portion, the stem portion thereby cooperating with the body portion when in the closed position to prevent liquid and gas flow through the fluid passages by sealing the vent and the groove, and wherein the stem portion can be positioned in the open position by threadably disengaging the externally threaded lower section from the internally threaded section of the body portion and moving the stem portion downwardly through the body aperture to engage the upper section with the body portion, the stem portion thereby cooperating with the body portion when in the open position to permit liquid and gas flow simultaneously and separately in the fluid passages by unsealing the groove to permit liquid to drain from the vessel through the first fluid passage and unsealing the vent to permit gas to enter the vessel through the second fluid passage.

2. The self-venting drain valve as defined in claim 1, wherein the vent is disposed above the groove.

3. The self-venting drain valve as defined in claim 2, wherein the vent is disposed one-half inch above the groove.

4. The self-venting valve assembly as defined in claim 1, wherein the ratio of the cross-sectional area of the first fluid passage to the cross-sectional area of the second fluid passage is in a range between about 10 to about 20.

5. The self-venting valve assembly as defined in claim 4, wherein the ratio of the cross-sectional area of the first fluid passage to the cross-sectional area of the second fluid passage is approximately 15.

6. The self-venting drain valve as defined in claim 1, wherein the internally threaded section of the body portion is positioned in threading engagement with the externally threaded lower section of the stem portion to seal the groove when the stem portion in the closed position.

7. The self-venting drain valve as defined in claim 1, wherein the externally threaded lower section of the stem portion is positioned in threading engagement with the internally threaded section of the body portion to seal the vent when the stem portion in the closed position.

8. The self-venting drain valve as defined in claim 1, wherein the stem portion further includes a plurality of retaining nibs radially projecting from the upper section, the retaining nibs being configured to engage the upper end of the body portion to retain the stem portion and ensure the stem aperture remains within the body portion in fluid communication with the vessel when the stem portion is in the open position.

9. The self-venting drain valve as defined in claim 1, further comprising a gasket disposed annularly around the stem portion and positioned immediately beneath the externally threaded lower section, the gasket being configured to assist in sealing the vent and the groove when the stem portion is in the closed position.

10. The self-venting drain valve as defined in claim 1, wherein the upper end of the body portion further comprises a flange projecting substantially vertically into the vessel.

11. The self-venting drain valve as defined in claim 1, wherein the vent is substantially annular in shape and disposed around the exterior surface of the stem portion.

12. The self-venting drain valve as defined in claim 1, further comprising an operating knob positioned outside the vessel and disposed on the lower section of the stem portion.

13. The self-venting drain valve as defined in claim 12, wherein the operating knob and the stem portion are integrally formed as a one-piece unitary valve member.

14. The self-venting drain valve as defined in claim 13, wherein the valve member is made of a plastic material.

15. The self-venting drain valve as defined in claim 14, wherein the valve member is manufactured by an injection molding process.

16. The self-venting drain valve as defined in claim 13, wherein the valve member is made of a material selected from the group consisting of stainless steel, aluminum, and zinc.

17. The self-venting drain valve as defined in claim 13, wherein the operating knob is provided with a drain reservoir to accumulate liquid drainage from the vessel exiting the groove.

18. The self-venting drain valve as defined in claim 17, wherein the drain reservoir is substantially annular in shape.

19. The self-venting drain valve as defined in claim 18, wherein the operating knob further includes a drain spout adapted to connect a hose and to pass liquid drainage from the vessel exiting the groove therethrough without spillage.

20. The self-venting drain valve as defined in claim 13, wherein an outer peripheral surface of the operating knob further includes a wrench socket adapted to receive a wrench for rotatably adjusting the stem portion within the body aperture between the closed position and the open position.

21. The self-venting drain valve as defined in claim 13, wherein a generally cylindrical outer peripheral surface of the operating knob is provided with axially oriented ribs.
